(19) United States
(12) Patent Application Publication
(10) Pub. No.: US 2014/0279626 A1
(43) Pub. Date: Sep. 18, 2014

(54) SYSTEM AND METHOD FOR MANAGING SOCIAL RELATIONSHIP INFORMATION

(71) Applicants: Smart Comz Co., Ltd., Seoul (KR); INNOSPARK INC., Seoul (KR)

(72) Inventors: Euddeum Joo, Seoul (KR); Jaechan Shin, Seongnam-si (KR)

(21) Appl. No.: 14/353,292

(22) PCT Filed: Sep. 17, 2012
(86) PCT No.: PCT/KR2012/007407

§ 371 Date: Apr. 22, 2014

(30) Foreign Application Priority Data
Oct. 25, 2011 (KR) 10-2011-0109517

(51) Int. Cl. G06Q 50/00; G06Q 10/00

(52) U.S. Cl. CPC G06Q 50/01; G06Q 10/00
USPC 705/319

(57) ABSTRACT

Disclosed are a system and a method for providing social relationship information about a user of various communication terminals, the system for providing social relationship information comprising: a related-person information storage unit for storing information about related-persons who are in contact with a user via a communication network; a contact record storing unit for gathering and storing communication contact records for the user and the related-persons; a relationship index calculation unit for calculating a social relationship index by analyzing the communication contact records; and a group information management unit for generating group information about the related-persons on the basis of the calculated social relationship index, and then providing the generated group information to a social network server or application.

### TECHNICAL FIELD

The present invention relates to a system and method for managing social relationship information about a user using a communication network, and more particularly, to a technique for grouping related persons with which a user establishes social relationships by communication contact, managing the related persons on a group basis, and providing group information to a Social Networking Service (SNS) or providing an SNS directly to the user based on the group information.

### BACKGROUND ART

Owing to the expansion of a network infrastructure, the increased use of the Internet, and the development of mobile communication technology, users can use a communication service at any time in any place. As a consequence, efficiency and convenience are remarkably increased in business and everyday living and a great change is brought to the way people establish social relationships and interact with each other.

Such a major example is a new type of service called a SNS. The SNS is a service that enables a user to establish relationships with other unspecified persons through a communication network. SNS users start new relationships or strength existing relationships by the SNS. In addition to traditional SNSs such as Twitter or Facebook, new types of SNSs have been introduced. For example, recent SNS-based games are oriented to social relationships among gamers and thus offer opportunities to strength or expand the social relationships of the gamers, compared to conventional on-line games.

However, since most of SNSs are based on service subscription and explicit relationship building, the SNSs are slowly spread to users unfamiliar with the features of the SNSs. Meanwhile, communication terminal users which are potential or actual SNS users experience inconvenience in expanding their social relationships because explicit grouping should precede in order to contact persons having phone numbers or e-mail addresses stored in their communication terminals or a directory on the Internet individually or on a group basis.

### DISCLOSURE

### Technical Problem

An object of the present invention devised to solve the conventional problem is to provide a system and method for grouping related persons according to contact frequency, contact types, and social relationship type using information about the related persons stored in a communication terminal of a user and communication contact records between the user and the related persons and providing group information to a Social Network Service (SNS) or enabling information sharing and gaming on a group basis.

### Technical Solution

In an aspect of the present invention, a system for managing social relationship information includes a related person information storage unit for storing information about related persons with which a user has contacts through a communication network, a contact record storage unit for collecting communication contact records between the user and the related persons and storing the collected communication contact records, a social relationship index calculation unit for calculating social relationship indexes by analyzing the communication contact records, and a group information management unit for generating group information about the related persons based on the calculated social relationship indexes and providing the group information to a social network server or a social network application.

The relationship index calculation unit may calculate the social relationship indexes by weighting at least one of the number of contacts, a contact frequency, a contact time, and the amount of communication data.

The relationship index calculation unit may calculate the social relationship indexes by weighting at least one of contact types between the user and the related persons, the contact types being voice or video call, text message transmission, file transmission, and scheduling reference.

Further, the relationship index calculation unit may calculate the social relationship indexes by weighting the communication contact records by date or by time or may update the social relationship indexes in every predetermined period.

The group information management unit may update the group information based on a user input.

In another aspect of the present invention, a method for managing social relationship information includes storing information about related persons with which a user has contacts through a communication network, collecting communication contact records between the user and the related persons and storing the collected communication contact records, calculating social relationship indexes by analyzing the communication contact records, and generating group information about the related persons based on the calculated social relationship indexes and managing the group information.

The communication contact records may be collected and stored by collecting and storing at least one of the number of contacts, a contact frequency, a contact time, and the amount of communication data, for at least one of contact types being voice or video call, text message transmission, file transmission, and scheduling reference.

The method may further include providing a social network service to the user based on the group information.

Specifics of other embodiments are incorporated in the following description and the attached drawings.

### Advantageous Effects

In the above system and method for managing social relationship information according to the embodiment of the present invention, group information is generated based on information about related persons and records of communication contacts with the related persons, thus enabling group contact based on the group information or a customized SNS according to the characteristics of a group. Therefore, the popularity of the SNS is increased and the social relationships of the user are strengthened or expanded. Further, since the group information is updated periodically, the group information adaptively reflects changes in the social relationships of the user. Accordingly, the user is relieved of inconvenience involved in manually generating related person groups and managing the groups.

### BRIEF DESCRIPTION OF THE DRAWINGS

FIG. 1 is a block diagram of a system for managing social relationship information according to an embodiment of the present invention;

FIG. 2 is a flowchart sequentially illustrating the steps of a method for managing social relationship information according to an embodiment of the present invention;

FIG. 3 illustrates an exemplary captured screen displaying a user's profile in a mobile social network application according to an embodiment of the present invention;

FIG. 4 illustrates an exemplary captured screen displaying a user's friend list in the mobile social network application according to an embodiment of the present invention;

FIG. 5 illustrates an exemplary captured screen displaying short profiles of a user's friends near to the user, along with their distances in the mobile social network application according to an embodiment of the present invention;

FIG. 6 illustrates an exemplary captured screen displaying a chatting window between a user and another user registered as a friend of the user's in the mobile social network application according to an embodiment of the present invention; and

FIG. 7 illustrates an exemplary captured screen providing a new friend recommend service to a user based on group information 23 provided by a system 10 for managing social relationship information in the mobile social network application according to an embodiment of the present invention.

### BEST MODE FOR CARRYING OUT THE INVENTION

The configuration, operation, and other features of the invention will become apparent to those having ordinary skill in the art upon examination of the following embodiments of the present invention described with reference to the attached drawings. A detailed description of known functions or constructions will be omitted lest it should obscure the subject matter of the present invention. Terms used herein are defined in consideration of functions according to the present invention and may be changed according to the intention of a user or an operator or customs.

However, the present invention is not limited to the embodiments described below. Rather, the present invention may be implemented in many other ways. The embodiments of the present invention are provided to make the disclosure of the present invention comprehensive and give a comprehensive scope of the present invention to those skilled in the art. The present invention is defined by the scope of the claims and the definition should be made based on the comprehensive contents of the present specification.

Meanwhile, combinations of respective blocks of the accompanying block diagrams may be formed using computer program instructions. Since the computer program instructions may be mounted in general-purpose computers, special-purpose computers or processors of programmable data processing equipment, the instructions executed through the computers or processors of other programmable data processing equipment generate units to perform the functions described in the respective blocks of the block diagrams. Since the computer program instructions may be stored in a computer-usable or computer-readable memory oriented to computers or other programmable data processing equipment in order to implement functions in a specific method, the instructions stored in the computer-usable or computer-readable memory may be used to manufacture products containing instruction units to perform the functions described in the respective blocks of the block diagrams. Since the computer program instructions may be mounted in computers or other programmable data processing equipment, instructions which perform a series of operation steps on the computers or other programmable data processing equipment to generate processes executed by the computers and operate the computers or other programmable data processing equipment may provide steps for performing the functions described in the respective blocks of the block diagram.

Furthermore, each of the blocks may indicate a part of a module, a segment or code including one or more executable instructions for executing specific logical functions. In some alternative embodiments, the functions described in the blocks may be performed in some other sequence. For example, the functions of two successive blocks may be performed substantially at the same time, or may be performed in reverse order depending on the corresponding functions.

Now, embodiments of the present invention will be described in detail with reference to the attached drawings.

In the embodiments of the present invention, a computer refers to any calculation means that can collect, read, process, store, and display data, such as a desktop computer, a laptop computer, a tablet Personal Computer (PC), a smartphone, a Personal Digital Assistant (PDA), a portable phone, a game console, etc. Particularly, the computer is a device that can execute software written in an interpretable code and display the executed software to a user in an embodiment of the present invention. Further, the computer can store software in it or read software together with data from the outside, when needed.

In an embodiment of the present invention, the computer is equipped with functions such as input, output, save, etc. as well as the afore-described data process function. Thus, the computer may include various components of a general computer, such as a Central Processing Unit (CPU), a main board, a graphic card, a hard disk, a sound card, a speaker, a keyboard, a mouse, a monitor, a Universal Serial Bus (USB), a communication modem, etc. One or more functions can be realized by using these components alone or in combination or by combining parts of the components. In an embodiment of the present invention, a device illustrated in one or more blocks in the drawings or the following description or a part of the device may perform one or more functions realized by using these components alone or in combination or by combining parts of the components.

In an embodiment of the present invention, the computer may have communication functionalities. To implement the communication functionalities, various network means may be provided, such as a wired Internet, a wireless Internet, infrared communication, Bluetooth, Wideband Code Division Multiple Access (WCDMA), Wireless Broadband (WiBro), Wireless Fidelity (WiFi), Long Term Evolution (LTE), a wired/wireless telephony network, etc.

FIG. 1 is a block diagram of a system for managing social relationship information according to an embodiment of the present invention. Referring to FIG. 1, a system 10 for managing social relationship information includes a related person information storage unit 11 for storing information about related persons with which a user have contacted through a communication network, a contact record storage unit 12 for collecting and storing communication contact records 21 between the user and the related persons, a relationship index calculation unit 13 for calculating social relationship indexes 22 by analyzing the communication contact records 21, and a group information management unit for generating group information 23 about the related persons based on the calculated social relationship indexes 22 and providing the generated group information 23 to a social network server or a social network application.

The related person information storage unit 11 may directly use a database such as contacts, a directory, a phonebook, a mailing list, etc. stored in a terminal equipped with a communication function such as a computer, a PDA, a portable phone, a smartphone, etc. or may extract information (e.g., phone numbers, e-mail addresses, etc.) required to analyze the contract records 21 and generate the group information 23 from the database and store the information in fields or as Identifiers (IDs). Or the related person information storage unit 11 may collect related person information from a directory on the Internet (e.g., a Google directory, a Nate directory, a Facebook mate list, etc.) and build a related person information database in a communication terminal of the user.

If the related person information is kept in the communication terminal of the user, the related person information storage unit 11 preserves the related person information in a built-in/external memory of the communication terminal.

Or the related person information database may be stored in a separate server by synchronizing the related person information database with a specific directory on the Internet. In this case, the related person information storage unit 11 may have a function of processing the related person information to an appropriate format transmittable to the server. The user may contact with related persons through the communication terminal by a call, e-mail, messaging, etc. and may add a related person or update the related person information. Accordingly, if the related person information database is stored in a plurality of communication terminals or a server other than the communication terminal, a specific terminal or the server preferably reflects an update in the related person information storage unit 11 by synchronization, etc. In this case, the related person information storage unit 11 may have a structure for receiving related person information from the server or the like and reflecting the received related person information in the related person information database.

The contact record storage unit 12 is configured so as to collect and store records of contacts made between the user and the related persons through a communication network, that is, the communication contact records 21. For each related person, the contact record storage unit 12 collects and stores record elements such as the number of contacts, a contact frequency, a contact time, and the amount of communication data for each of various contact types including voice/video calls, text message transmission, file transmission, scheduling reference, etc. Herein, the related person database of the related person information storage 11 is referred to. The communication contact records 21 having the various contact types and record elements may be classified by date and stored along with date information or time information. This is done to weight the communication contact records 21 by date or time for use in calculating the social relationship indexes 22 which will be described below.

The relationship index calculation unit 13 calculates the social relationship indexes 22 of the related persons whose information is stored in the related person database by analyzing the communication contact records 21 stored in the contact record storage unit 12. This analysis may be performed using a ranking scheme that assigns a high rank to a related person having frequent contacts or many contacts with the user according to a contact frequency and the number of contacts. Or the social relationship indexes 22 may be evaluated in a multi-sided manner by a pattern analysis scheme based on a contact time and a contact type. In this manner, ranks represented by the social relationship indexes 22 may be expressed, processed, or stored in the form of multi-dimensional indexes having a plurality of parameters, not one-dimensional indexes having a single element, rank.

In the case where a plurality of contact types and/or a plurality of record elements are considered in analyzing the communication contact records 21, the relationship index calculation unit 13 may assign a predetermined weight to each contact type or record element and calculate the social relationship indexes 22 using the weighted contact types or record elements. The relationship index calculation unit 13 may evaluate the communication contact records 21 differently according to dates or time. For example, the relationship index calculation unit 13 may assign a higher weight to a latest contact. In another example, the relationship index calculation unit 13 may evaluate a contact made in the day and a contact made at night as different types or may assign different weights to a communication contact in a weekday and a communication contact on a weekend.

Or when messages are exchanged, the relationship index calculation unit 13 may assign a higher weight to a reply to a first message of one party than to the first message.

The relationship index calculation unit 13 may update the social relationship indexes 22 in every predetermined period. The index update period may be set to be equal to an update period of the related person information database. When needed, the index update period may be set differently. The update period of the social relationship indexes 22 may be preset to a specific value or may be changed adaptively according to the frequency and number of communication contacts. Or the social relationship indexes 22 may be updated in conjunction with an aperiodic update of the related person information database triggered by a directory update of the user. It is obvious that the above update schemes may be used in combination.

The social relationship indexes 22 calculated by the relationship index calculation unit 13 are provided to the group information management unit 14, for use in grouping the related persons. The group information management unit 14 groups a plurality of related persons based on their social relationship indexes 22 according to a predetermined criterion. As described before, the social relationship indexes 22 may be expressed as multi-dimensional indexes including multi-dimensional evaluation elements. Therefore, the group information 23 may be generated in such a manner that a first group has an intersection with a second group or the first group includes the second group, as well as in such a manner that the plurality of related persons are grouped into mutually exclusive groups.

The group information 13 about the related person groups is provided to the social network server or the social network application. The social network server may be a conventional SNS server operated by a separate operator or an intelligent, integrated social network server that provides a customized SNS to each related person group using the group information 23 received from the social relationship information management system 10 according to the embodiment of the present invention. While the social network application that receives the group information 23 may be a third application already installed in the communication terminal of the user, the social network application may be an application incorporated in the social relationship information management system 10 according to the embodiment of the present invention. Because the group information 23 provided by the social relationship information management system 10 according to the embodiment of the present invention may include multi-dimensional evaluation elements and may be updated intelligently, a new SNS that can provide a customized service to each related person group as well as a typical SNS can be implemented.

In an embodiment of the present invention, for example, the social network server or the social network application may provide a service of recommending a new friend to a user based on the group information 23 provided by the social relationship information management system 10 according to the embodiment of the present invention. Specifically, in the case where second and third users belong to the same group for a first user based on the group information 23 about the first user but do not have a direct social relationship between them, if the second and third users have scores equal to or higher than a predetermined threshold based on their social relationship indexes 22, a friend recommend message or notification may be transmitted to the second and third users so that the second and third users may start a social relationship. Or in the case where the second and third users belong to the same two or more groups for the first user based on the group information 23 about the first user, the second and third users may be considered to have a high social correlation between them and thus a friend recommend message or notification may be transmitted to the second and third users so that the second and third users may start a social relationship.

FIGS. 3 to 7 illustrate screens on which a social network application is executed according to an embodiment of the present invention.

FIG. 3 illustrates an exemplary captured screen displaying a user's profile in a mobile social network application according to an embodiment of the present invention.

FIG. 4 illustrates an exemplary captured screen displaying a user's friend list in the mobile social network application according to an embodiment of the present invention;

FIG. 5 illustrates an exemplary captured screen displaying short profiles of a user's friends near to the user, along with their distance in the mobile social network application according to an embodiment of the present invention;

FIG. 6 illustrates an exemplary captured screen displaying a chatting window between a user and another user registered as a friend of the user's in the mobile social network application according to an embodiment of the present invention; and

FIG. 7 illustrates an exemplary captured screen providing a new friend recommend service to a user based on the group information 23 provided by the system 10 for managing social relationship information in the mobile social network application according to an embodiment of the present invention.

The group information management unit 14 may be configured to update the group information 23 based on a user input. Thus the user may directly amend the result of grouping which has been automatically performed according to the user's communication contact records 21 and the social relationship indexes 22 calculated based on the communication contact records 21. The group information management unit 14 may include a structure for feeding back an update of the group information 23 as learning information in response to a user input by a learning algorithm, so that a grouping algorithm may be adjusted appropriately for each user.

Now, a method for managing social relationship information according to another embodiment of the present invention will be described step by step. Unless otherwise mentioned, it is to be understood that the description of the system for managing social relationship information according to the foregoing embodiment of the present invention applies to the method for managing social relationship information according to this embodiment of the present invention. The opposite case is also applicable. That is, the description of the method according to this embodiment of the present invention applies to the system according to the foregoing embodiment of the present invention.

FIG. 2 is a flowchart sequentially illustrating the steps of a method for managing social relationship information according to an embodiment of the present invention. Referring to FIG. 2, the method for managing social relationship information according to the embodiment of the present invention includes a step for collecting and storing information about related persons with which a user has contacted through a communication network using a communication terminal of the user (S11), a step for collecting and storing the communication contact records 21 between the user and the related persons (S12), a step for calculating the social relationship indexes 22 of the related persons by analyzing the communication contact records 21 (S13), and a step for generating and managing the group information 23 about the related persons based on the calculated social relationship indexes 22 (S14).

In step S11, information about the related persons with which the user has contacted by communication is collected from various communication terminals such as a computer, a portable phone, a smartphone, etc. and then stored. If the method for managing social relationship information according to the embodiment of the present invention is performed directly on a specific communication terminal of the user, the related person information may be collected directly from the communication terminal, to which the method for collecting related person information is not limited. Related person information input or updated through a directory on the Internet may be collected, or related person information input or updated in another communication terminal of the user may be collected by synchronization (through short-range communication, wired communication, or a third server). Accordingly, the expression ‘collected from a terminal’ should be interpreted as a broad meaning including synchronization of related person information input and updated in a third terminal or indirect collection by synchronization with related person information input or updated in an Internet directory through the third terminal, as well as directly accessing a database such as a directory, contacts, a phone number, a mailing list, etc. of the communication terminal and extracting related person information from the database.

In step S12, the user collects the records 21 of communication contacts made between the user and the related persons through one or more communication terminals and stores the communication contact records 21. The communication contact records 21 may include contact types such as voice/video call, text message transmission, file transmission, scheduling reference, etc. and record elements such as the number of contacts, a contact frequency, a contact time, and the amount of communication data, for each contact type.

Subsequently, in step S13, the social relationship indexes 22 of the related persons are calculated by analyzing the communication contact records 21 collected in step S12. One or more contact types and record elements may be considered in calculating the social relationship indexes 22. If a plurality of contact types and/or a plurality of record elements are considered in calculating the social relationship indexes 22, a predetermined weight may be assigned to each contact type and/or each record element. The communication contact records 21 may be evaluated in a one-dimensional ranking scheme or a multi-dimensional evaluation scheme in which a plurality of contact types and/or a plurality of record elements are considered in combination from various aspects. In the former case, the social relationship indexes 21 are represented as one-dimensional indexes, whereas in the latter case, the social relationship indexes 21 are represented as multi-dimensional indexes having a plurality of parameters. Meanwhile, date information or time information may be used in calculating the social relationship indexes 21.

In step S14, the related persons are grouped based on the social relationship indexes 21 calculated in step S13. The related persons may be grouped according to the ranks of social relationships represented by the social relationship indexes 21 or according to a complex grouping method based on a pattern analysis of multi-dimensional evaluation elements. In the latter case, the grouping may result in a plurality of groups that are not mutually exclusive.

In an embodiment of the present invention, a step for providing an SNS to the user based on the group information 23 may be added to the above-described steps S11 to S14. Since this step uses the group information 23 generated in step S14, it follows step S14 logically. However, once the group information 23 is generated for the first time in the flow from step S11 to S14, the step for providing an SNS may be performed continuously, independently of the steps S11 to S14. In addition, the provided SNS may include services such as an SNS game, sharing of materials and information, etc. based on the group information.

By law, a user's agreement may be requested on collection, storing, synchronization, and processing of related person information and collection, storing, synchronization, and analysis of communication contact records, which have been described in the foregoing embodiments of the present invention. However, a system configuration or step for acquiring a user's agreement is beyond the scope of the present invention and thus is not described herein. Nonetheless, if the configuration or step is required, the configuration or step may be incorporated in one of the afore-described components or steps.

The present invention may be implemented as computer-readable code in a computer-readable recording medium. The computer-readable recording medium may include any kind of recording device storing computer-readable data. Examples of the recording medium may include Read Only Memory (ROM), Random Access Memory (RAM), Compact Disk Read Only Memory (CD-ROM), magnetic tape, floppy disk, optical data storing device, and the like. In addition, the computer-readable recording medium may be distributed over the computer systems connected over the network, and computer-readable codes may be stored and executed in a distributed manner.

Modules, function blocks, or means in the embodiments of the present invention may be implemented as various known devices such as electronic circuits, Integrated Circuits (ICs), Application Specific Integrated Circuits (ASICs), and the like. These devices may be implemented alone or in a combination of two or more.

Those skilled in the art will appreciate that the present invention may be carried out in other specific ways than those set forth herein without departing from the spirit and essential characteristics of the present invention. For example, those skilled in the art will understand that the material, size, etc. of each component may be changed according to an application field or the disclosed embodiments may be combined or replaced within the scope and spirit of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1. A system for managing social relationship information, the system comprising:
a related person information storage unit for storing information about related persons with which a user has contacts through a communication network;
a contact record storage unit for collecting communication contact records between the user and the related persons and storing the collected communication contact records;
a social relationship index calculation unit for calculating social relationship indexes by analyzing the communication contact records; and
a group information management unit for generating group information about the related persons based on the calculated social relationship indexes and providing the group information to a social network server or a social network application.

2. The system according to claim 1, wherein the relationship index calculation unit calculates the social relationship indexes by weighting at least one of the number of contacts, a contact frequency, a contact time, and the amount of communication data.

3. The system according to claim 1, wherein the relationship index calculation unit calculates the social relationship indexes by weighting at least one of contact types between the user and the related persons, the contact types being voice or video call, text message transmission, file transmission, and scheduling reference.

4. The system according to claim 1, wherein the group information management unit updates the group information based on a user input.

5. The system according to claim 1, wherein the relationship index calculation unit calculates the social relationship indexes by weighting the communication contact records by date or by time.

6. The system according to claim 1, wherein the relationship index calculation unit updates the social relationship indexes in every predetermined period.

7. A method for managing social relationship information, the method comprising:
storing information about related persons with which a user has contacts through a communication network;
collecting communication contact records between the user and the related persons and storing the collected communication contact records;
calculating social relationship indexes by analyzing the communication contact records; and
generating group information about the related persons based on the calculated social relationship indexes and managing the group information.

8. The method according to claim 7, wherein the communication contact records are collected and stored by collecting and storing at least one of the number of contacts, a contact frequency, a contact time, and the amount of communication data for at least one of contact types,
and wherein the at least one of contact types is voice or video call, text message transmission, file transmission, and scheduling reference.

9. The method according to claim 7, further comprising providing a social network service to the user based on the group information.

10. A recording medium storing computer software in which the method according to claim 7 is written in computer-readable code.

11. The system according to claim 1, wherein the social network server or the social network application transmits a friend recommend message or notification to each of related persons belonging to the same two or more groups based on the group information from among the related persons of the user.

12. The system according to claim 1, wherein the social network server or the social network application transmits a friend recommend message or notification to each of related persons belonging to the same group based on the group information and having a mutual social relationship index being equal to or higher than a predetermined value, from among the related persons of the user.

13. A recording medium storing computer software in which the method according to claim 8 is written in computer-readable code.

14. A recording medium storing computer software in which the method according to claim 9 is written in computer-readable code.
